(19) United States
(12) Patent Application Publication
(10) Pub. No.: US 2003/0007608 A1
(43) Pub. Date: Jan. 9, 2003

(54) System and method for making calls to vanity numbers using voice dialing

(76) Inventors: Bruce Melvin Buntschuh, Mountain View, CA (US); Candace Ann Kamm, Morristown, NJ (US)

Correspondence Address: SAMUEL H. DWORETSKY, AT & T CORP., PO BOX 4110, MIDDLETOWN, NJ, 07748, US

(21) Appl. No.: 09/899,538

(22) Filed: Jul. 6, 2001

(51) Int. Cl. H04M 1/64

(52) U.S. Cl. 379/88.01

(57) ABSTRACT

A system and method for calling a toll-free or vanity number using speech recognition is provided. The system and method of the present invention allow a user to speak or spell the contents of a toll-free vanity number or personal vanity number. An automatic speech recognition system interprets the users speech to make an appropriate connection to the toll-free vanity number or personal vanity number.

### BACKGROUND OF THE INVENTION

1. Field of the Invention

The present invention relates to a system and method for using a toll-free or personal telephone number database as a vocabulary for speech recognition. More particularly, the present invention is directed to a system and method that facilitates making calls to personal or toll-free vanity numbers using voice dialing.

2. Description of the Prior Art

Voice-dialing that allows a user to associate a spoken word or phrase with a telephone number is well known. For example, U.S. Pat. No. 5,912,949 to Chan et al. discloses a voice-dialing system using both spoken names and initials in recognition. According to the Chan et al. system the user creates and stores a directory of names and associated telephone numbers on a storage medium such as a hard disk. When the user speaks, a speech recognition component attempts to match the input to the stored set of representations corresponding to each name in the directory. The Chan et al. system performs an input confirmation process to make sure the voice input data is understood. If the system does not return the desired telephone number in response to the spoken name, the user may speak the called parties initials to direct the system to the correct number.

The Chan et al. and other voice dialing systems require the user to take time to create a directory of names and corresponding numbers. This process may require the users to provide voice samples for each party in the directory. Furthermore, the voice dialing system may only work for names and numbers entered into the system. Every time the user wants to add a number to the directory, the data entry process must be repeated. The foregoing is true regardless of whether the called number is a personal, business, vanity, or toll-free number.

Conventional voice dialing systems maintain a database of numbers and called party names, where the name of the called party must be spoken so that the system can look for a corresponding number. There is no provision for speaking the number when the number is a toll-free vanity number or personal vanity number.

The specific details of conventional voice recognition techniques are well known. U.S. Pat. No. 5,987,408 to Gupta, discloses an automated directory assistance system utilizing a heuristics model for predicting the most likely requested number. Further, U.S. Pat. No. 5,987,414 to Sabourin et al. discloses a method and apparatus for selecting a vocabulary sub-set from a speech recognition dictionary for use in real time automated directory assistance. Names in a directory may be represented by a sequence of orthographic letters, and the retrieval process may involve comparing the names in a directory with the user's speech pattern using a phoneme-level representation for the names.

Personal vanity telephone numbers and often toll-free vanity telephone numbers take advantage of the correspondence of the numbers 2-9, on the telephone dial, with the letters of the alphabet. The number 2 corresponds to the letters A, B and C, 3 to D, E, and F, 4 to G, H, and I, 5 to J, K, and L, 6 to M, N, and O, 7 to P, Q, R, and S, 8 to T, U, and V, and 9 to W, X, Y, and Z. The numbers 1 and 0 have no corresponding letters. Based on this correspondence toll-free vanity numbers, such as 1-800-FLOWERS, or 1-800 CALL ATT, can be easily remembered. However, it is often difficult for the user to determine or remember what the numerical telephone number is without looking at the telephone dial. Such conversion is often awkward for the user.

### SUMMARY OF THE INVENTION

The deficiencies of the conventional systems and methods are addressed by the present invention that is directed to a system and method for calling a toll-free vanity number or personal vanity number using speech recognition. In particular, the system and method of the present invention allows a user to speak or spell the contents of a personal or toll-free vanity number. An automatic speech recognition system interprets the users speech to make an appropriate connection.

An advantage of the system and method of the present invention is that it does not require the user to create a database of numbers and corresponding voice patterns.

Another advantage of the system and method according to the present invention is that it provides a simple way for users to call toll-free or personal vanity numbers with ordinary speech.

Yet another advantage of the system and method according to the present invention is that it simplifies the process of calling toll-free or personal vanity numbers by eliminating the need for the user to determine the correspondence between letters and numbers on a telephone dial.

Still another advantage of the system and method according to the present invention is that it eliminates the awkwardness encountered when dialing a toll-free vanity number or personal vanity number.

Another advantage of the system and method according to the present invention is that it allows a user to call a toll-free vanity number or personal vanity number without knowing the name of the party or company called.

### BRIEF DESCRIPTION OF THE DRAWINGS

These and other attributes of the present invention will be described with respect to the following drawings in which:

FIG. 1 is a block diagram of the system according to the present invention; and

FIG. 2 is a flow chart of the operation of the method according to the present invention.

### DETAILED DESCRIPTION OF THE INVENTION

The system and method of the present invention helps telephone users overcome the awkwardness they may experience when using a toll-free vanity number or personal vanity number, such as 1-800-FLOWERS, or 1-800 CALL ATT. The system and method allow a user to speak and/or spell, the contents of the vanity number, thereby eliminating the need for the user to convert the letters and/or words to their key pad/decimal equivalent.

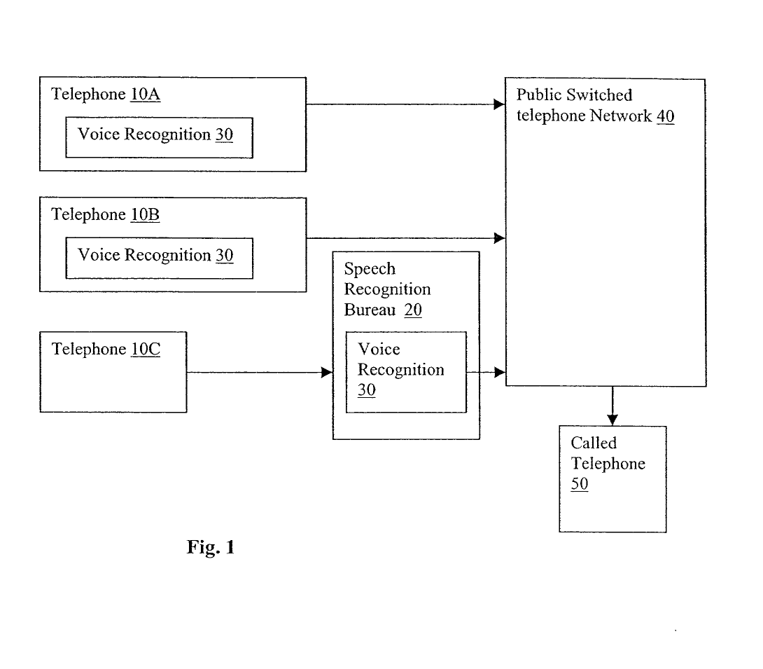

Referring to FIG. 1, a block diagram representation of the system of the present invention is shown. Users access the system through telephones 10. The telephones 10 may be hardwired phones, including cordless telephones, 10A, cellular phones 10B, or pay phones 10C. Automatic speech recognition technology is used to interpret a user's speech so that the appropriate connection can be made. The automatic speech recognition (ASR) can be accomplished at the end-user device (i.e., the telephone) or a user can be connected to a network-based system containing or connected to an ASR server 20 that will allow them to speak a toll-free or personal vanity number. The ASR server may be provided to the users via the same speech recognition technology 30 infrastructure and similar user interface to that deployed in conventional voice dialing. For conventional pay phones, the voice recognition 30 will probably be provided through a network-based ASR server 20. The ASR server can be incorporated in the network switch, or can exist on an adjunct speech-enabling platform.

While the illustrated embodiments utilize telephones cordless telephones 10A, cellular telephone 10B or pay phones 10C, the present invention is not intended to be limited to these examples. The system and method of the present invention would work with an ASR for speaking vanity numbers into the microphone on a computer (PC) or personal digital assistant (PDA) to initiate an IP (Internet Protocol) phone call. In such an instance, the PSTN (Public Switched Telephone Network), shown in FIG. 1, would be replaced by an IP network or combination of IP network and the switched telephone network. In general any device that can be spoken in to, and is connected to a system that can complete phone calls, either over the PSTN, private switched networks and/or via IP gateways, can implement the present invention.

The ASR server 20 provides the same voice recognition capabilities 30 as the speech recognition technology 30 provided in some cellular phones 10. The ASR server 20 converts the vocalization from the user into the appropriate number. The vocalization may be a spoken or spelled vanity number. Telephones 10 are connected, either directly or through the ASR server 20 to the public switched telephone network 40, and then to the called telephone 50 at the desired telephone number.

The only difference between the telephones 10 having voice recognition 30 and the telephones 10 that do not have the voice recognition 30 is the location where the voice recognition occurs. The differences are virtually invisible to the users. The only difference the users will experience is for telephones 10 that do not have voice recognition capabilities 30, the users will have to dial in to a system containing or connected to the ASR server 20. From that point on the entire procedure is identical regardless of the type of telephone10 that is used.

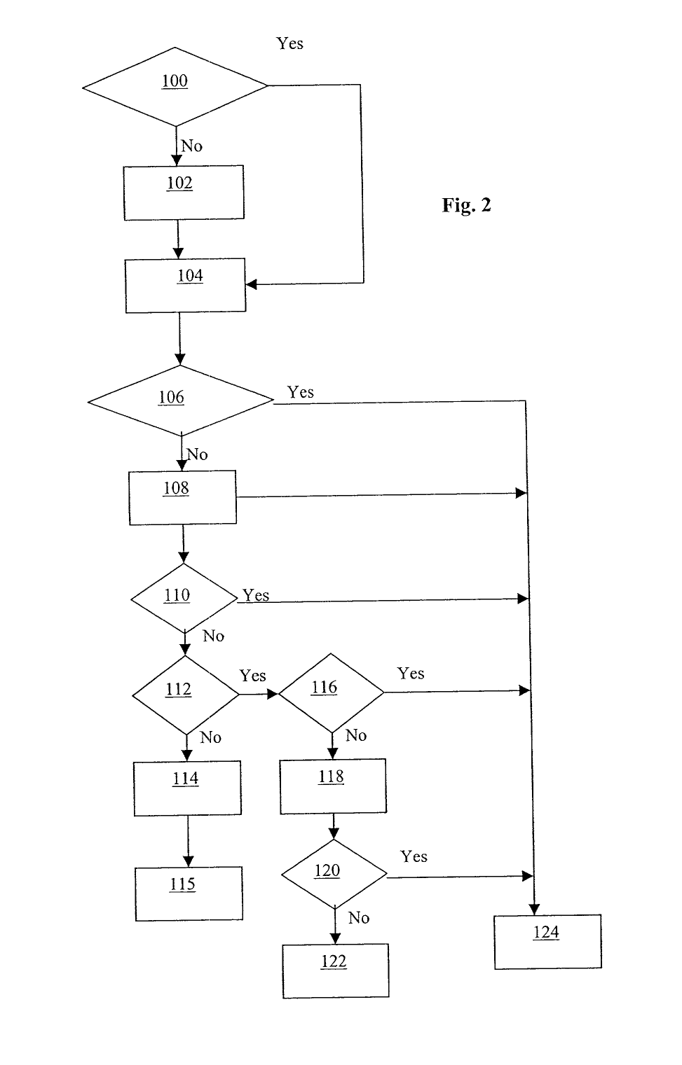

The method of operation for making calls to toll-free or personal vanity numbers using voice dialing according to the present invention will now be described with reference to FIG. 2. In step 100, a determination is made whether the user is calling from a telephone 10 having voice recognition capabilities 30. If the answer in step 10 is “No” then the user is required to call the system containing or connected to the ASR server 20, in step 102. If the answer in step 100 is “Yes,” or after the user has called the ASR server 20 in step 102, the user then speaks or spells the toll-free or personal vanity number in step 104.

The mapping of vanity numbers to the grammar of the speech recognition system may be produced using various rules and heuristics to generate appropriate pronunciations for each vanity number. Such rules and heuristics can be programmed in to the voice recognition 30, in a manner known to one skilled in the art.

The voice recognition 30 uses rules and heuristics to determine the desired number, in step 106. The rules can be preprogrammed or set dynamically. For example, if the user wishes to call 1-800-FLOWERS, the voice recognition will determine that the desired number is 1-800-3569377. If the voice recognition cannot determine the number in step 106, then the user may be asked to repeat the number, in step 108. On the other hand, if the preprogrammed rules and heuristics determine the desired decimal number, in step 106, then the call is placed in step 124.

After the user repeats the vanity number in step 108, the voice recognition then attempts again to determine the desired number in step 110. If the voice recognition determines the decimal number in step 110, the call is placed in step 124. If the system still cannot determine the desired number, in step 110, a determination is made in step 112 whether the decimal number corresponding to the spoken vanity number has enough digits. If the determination in step 112 is that the vanity number does not have enough digits, the call will not be placed, in step 114, and an error message may be sent in step 115, to inform the caller that the vanity number is invalid. If the vanity number has the proper number of digits or has extra digits, then the voice recognition 30 dials the first seven-digit number and ignores the extra digits.

The number of digits required can vary from one originating location to a second originating location. Some originating locations require area codes, some require a “1” and the area code, and some originating locations require just the number without the area code. Furthermore, for international calls the number of required digits can vary even more depending on both the requirements for the originating location and the destination. The embodiments set forth herein are meant as merely as examples and are not intended to limit the scope of the system and method of the present invention.

If the decimal number corresponding to the vanity number has the proper number of digits, or more, a determination is made whether the number is a valid number, in step 116. If the decimal number corresponding to the spelled vanity number is valid in step 116, the call is put through in step 124.

If the result of the determination in step 116 is negative, the user may be asked to spell the number, in step 118. In step 120 a determination is made whether the spelled number is valid. If the result of step 120 is positive the call is placed in step 124. Otherwise the user may receive a typical message from the public switched telephone network 40 to the effect that the dialed number is not a valid number, in step 122.

When the system recognizes the number spoken, in step 106, or spelled, in step 120, the call is made in step 124. Alternatively, the user may spell the vanity number right away instead of speaking it. Such may be desirable when there are multiple vanity numbers that are homophones for one another, and provide the proper number of telephone number digits.

The system and method do not require the user to enter target names in a list, or require the actual name of the target company be uttered. Rather, the system and method exploit the often-advertised vanity number representation of a company or service. In the same manner that vanity numbers can make it easy to remember how to associate a company or service with a particular representation, the system and method of the present invention make it easy for users to actually connect to that company, service or person.

By providing a user-friendly interface, where the users can simply speak the toll-free or personal vanity number and be connected to the company, service or person, the business opportunities will be enhanced. While, the foregoing description refers to toll-numbers, the present invention is not meant to be limited to only toll-numbers. The system and method work equally well for phone numbers that are toll calls, such as 212-FLOWERS, 703-FLOWERS, etc. Consequently, the term “vanity number” as used herein is intended to mean a telephone number whose decimal representation corresponds to a word or words. For example 1-800-BIG DOGS would be a vanity number, as is the previously discussed 1-800-FLOWERS. Similarly, 1-800-BIG DOG 6 could be a vanity number as well.

The voice recognition 30 may be programmed to ignore extra digits that are produced in the conversion. For example, the toll-free vanity number might be 1-800-MATTRESS. The word “mattress” has eight letters, and therefore, if the corresponding number is 1-800-6288737, then the rules and heuristics may be written to ignore the extra “S” and dial the number that corresponds to the first seven digits.

In addition, the area code may also be incorporated into the personal vanity number. Thus, if the spoken word has ten digits the number will be dialed. For example, if a user says “1-BIG FLOWERS,” the full ten-digit number will be dialed.

As an alternative embodiment, the system may maintain a central database of phonetic pronunciations and corresponding telephone numbers. In this embodiment, when a personal or toll-free vanity number is added to the database, the desired phonetic pronunciation is selected along with the telephone number. When someone speaks a personal or toll-free vanity number into the phone using the system, the database is accessed to find a corresponding phonetic pronunciation. If a match is made the corresponding telephone number may be dialed. In order to insure that the proper match was found the system may provide feedback to the caller including an indication of the corresponding telephone number and/or the phonetic pronunciation.

The system using the foregoing database is more suited to toll-free vanity telephone numbers than local personal vanity numbers because it is a simpler matter to keep track of the phonetic pronunciations for the limited number of toll-free area-codes, i.e. 800, 877,888, etc. than for all area codes.

An advantage to the foregoing configuration is that where there are instances of different telephone numbers having vanity numbers that are homophones, the potential confusion may be eliminated. As an example, for the toll-free vanity numbers 1-800-SINGERS and 1-800-WRINGERS, there is a homophone for WRINGERS, namely RINGERS which if selected would provide the caller with an incorrect number, as RINGERS and SINGERS provide the same seven-digit number “7464377”. However, according to this embodiment, when the phonetic pronunciation is chosen for entry in the database, the spelling WRINGERS can be selected for return so that the number “9746437” is returned whenever a caller says WRINGERS or RINGERS, and “7464377 is returned when the caller says SINGER.

Having described several embodiments of the system and method for using a toll-free vanity number and personal vanity number database as a vocabulary for speech recognition in accordance with the present invention, it is believed that other modifications, variations and changes, such as using different languages besides English, will be suggested to those skilled in the art in view of the description set forth above. It is therefore to be understood that all such variations, modifications and changes are believed to fall within the scope of the invention as defined in the appended claims.

What is claimed is:

1. A system for calling a vanity number using speech recognition, comprising:
at least one telephone;
a speech recognition system; and
a switched telephone network;
wherein said speech recognition system receives a spoken or spelled vanity number and produces a corresponding decimal number by converting letters in said vanity number into corresponding key pad/decimal equivalents.

2. A system for calling a vanity number using speech recognition, as recited in claim 1, wherein said speech recognition system is incorporated into said at least one telephone.

3. A system for calling a vanity number using speech recognition, as recited in claim 2, wherein said at least one telephone is a cellular phone.

4. A system for calling a vanity number using speech recognition, as recited in claim 2, wherein said at least one telephone is a hard wired telephone.

5. A system for calling a vanity number using speech recognition, as recited in claim 1, wherein said speech recognition system is disposed in a one of a network-based ASR server connected to the PSTN, a private switched telephone network, and an IP gateway.

6. A system for calling a vanity number using speech recognition, as recited in claim 1, wherein said speech recognition system determines said decimal telephone number to be the first digits derived from a spoken vanity number.

7. A system for calling a vanity number using speech recognition, as recited in claim 6, wherein said speech recognition system ignores extra digits, beyond the first digits derived from said spoken vanity number, when said spoken vanity number produces more decimal digits, than required for a decimal telephone number.

8. A system for calling a vanity number using speech recognition, comprising:
at least one telephone;
a speech recognition system; and
a switched telephone network;
said speech recognition system receives a spoken or spelled vanity number and produces a corresponding decimal number by converting letters in said vanity number into corresponding key pad/decimal equivalents, and
said speech recognition system determines said decimal telephone number to be the first digits derived from a spoken vanity number, and disregards extra digits, beyond said first digits derived from said spoken vanity number, when said spoken vanity number produces more decimal digits than required for a decimal telephone number.

9. A system for calling a vanity number using speech recognition, as recited in claim 8, wherein said speech recognition system is incorporated into said at least one telephone.

10. A system for calling a vanity number using speech recognition, as recited in claim 8, wherein said at least one telephone is a cellular phone.

11. A system for calling a vanity number using speech recognition, as recited in claim 8, wherein said at least one telephone is a hard wired telephone.

12. A system for calling a vanity number using speech recognition, as recited in claim 8, wherein said speech recognition system is disposed in an ASR server.

13. A method for calling a vanity number using speech recognition, comprising the steps of:
receiving a vocalization of a vanity number;
determining a decimal telephone number from said vocalization; and
placing a telephone call to said decimal telephone number.

14 A method for calling a vanity number using speech recognition, as recited in claim 13, wherein said vocalization is a spoken vanity number.

15. A method for calling a vanity number using speech recognition, as recited in claim 13, wherein said vocalization is a spelled vanity number.

16. A method for calling a vanity number using speech recognition, as recited in claim 13, comprising the further step of repeating said determining step if said first determining step does not provide a valid decimal telephone number.

17. A method for calling a vanity number using speech recognition, as recited in claim 13, comprising the further step of repeating said receiving step if said determining step does not provide a valid decimal telephone number.

18. A method for calling a vanity number using speech recognition, as recited in claim 13, wherein said determining step is performed by a speech recognition system based upon rules and heuristics.

19. A method for calling a vanity number using speech recognition, as recited in claim 13, comprising the further step of determining if said decimal telephone number produced in said determining step has a sufficient number of digits, when said determining step produces an invalid decimal number.

20. A method for calling a vanity number using speech recognition, as recited in claim 19, comprising the further step of providing an error message when said decimal number is determined to have an insufficient number of decimal digits.

21. A method for calling a vanity number using speech recognition, as recited in claim 13, wherein said determining step further comprises the steps of:
determining said decimal telephone number to be the first digits derived from said vocalized vanity number, and
disregarding extra digits, beyond said first digits derived from said vocalized vanity number, when said vocalized vanity number produces more decimal digits than required for a decimal telephone number.

22. A method for calling a vanity number using speech recognition, as recited in claim 13, comprising the further step of requesting the vanity number be spelled if said determining step does not provide a valid decimal telephone number.

23. A method for calling a vanity number using speech recognition, as recited in claim 13, comprising, prior to said receiving step, the further step of placing a call to a system containing or connected to an ASR server when a phone from which a call is placed does not have voice recognition capability.
